(19) United States
(12) Patent Application Publication
(10) Pub. No.: US 2019/0322005 A1
(43) Pub. Date: Oct. 24, 2019

(54) MACHINE AND METHOD FOR COMPACTING POWDER MATERIAL

(71) Applicant: SACMI COOPERATIVA MECCANICI IMOLA SOCIETA COOPERATIVA, Imola (IT)

(72) Inventors: Paolo TESTI, Imola (IT); Marco SALIERI, Imola (IT)

(21) Appl. No.: 16/343,471

(22) PCT Filed: Oct. 19, 2017
(86) PCT No.: PCT/IB2017/056508

§ 371 Date: Apr. 19, 2019

(30) Foreign Application Priority Data
Oct. 19, 2016 (IT) 102016000105117

(51) Int. Cl. B28B 17/00; B28B 3/12

(52) U.S. Cl. CPC B28B 17/0081; B28B 3/123

(57) ABSTRACT

A machine and method for compacting ceramic powder; a layer of non-compacted ceramic powder is conveyed in a direction of advance through a compacting device, which comprises a pressure belt with a continuous base layer, a contact layer, having a structured contact surface, and an identification code, which is designed to identify the pressure belt in a substantially unequivocal way; the machine further comprises a detector to detect the identification code and a control unit, which is designed to determine, as a function of what is detected by the detector, how much the pressure belt is used and/or how many times the pressure belt is fitted into and/or removed from the machine.

### TECHNICAL FIELD

The present invention relates to a machine and a method for compacting a powder material, a line and a plant for the production of ceramic articles.

### BACKGROUND OF THE INVENTION

In the field of the production of ceramic articles the use is known of machines for compacting ceramic powder for the production of slabs, preferably thin (such as tiles) having a surface (typically of the side destined to remain exposed) having a plurality of ridges and valleys. Normally, this type of surface is called structured or with structured effect.

The structured effect gives the ceramic product a particular pleasant aesthetic value, for example in the case in which the aesthetic effect of natural materials such as wood or stone is to be imitated.

In some cases, these machines comprise a compacting device, which is arranged at a working station and is designed to compact the powder material so as to obtain a layer of compacted powder material having a structured surface; and a conveyor assembly to substantially continuously transport the ceramic powder along a given path through the working station. The compacting device comprises a pressure belt having a structured contact surface designed to compress the powder material from above to obtain the structured surface of the layer of compacted powder material.

The structured contact surface is subject to progressive wear due to prolonged contact with the powder material and must therefore be replaced at relatively frequent intervals. Moreover, in the majority of cases, the need to replace it is only discovered after a given amount of slabs of inferior quality have been produced. These slabs must be discarded. It is also noted that a part of the slabs that are not discarded are not of homogeneous quality. In this regard, it should in fact be noted that the last slabs of a batch produced by a same belt (even if acceptable) have the ridges of lower height and valleys of lower depth to those of the first slabs of the same batch.

The patent application by the same applicant with publication number WO2015114433A1 describes a particular embodiment of the pressure belt comprising a base layer on which there is deposited a contact layer of plastic material having the structured contact surface designed to create the desired (three-dimensional) relief geometry on the layer of powder material. In this case, the problems described above are particularly evident in view of the fact that the material with which the contact layer is produced is relatively prone to wear.

The patent application with publication number EP2921317A1 describes a pressing plate equipped with an RFID transponder.

The object of the present invention is to provide a machine and a method for compacting a powder material, a line and a plant for the production of ceramic articles, which allows the drawbacks of the prior art to be at least partly overcome and which are, at the same time, simple to produce with limited costs.

### SUMMARY

According to the present invention there are provided a machine and a method for compacting a powder material, a line and a plant for the production of ceramic articles as defined in the following independent claims and, preferably, in any one of the claims depending directly or indirectly on the independent claims.

### BRIEF DESCRIPTION OF THE FIGURES

The invention is described below with reference to the accompanying drawings, which illustrate some non-limiting examples of embodiment thereof, wherein:

FIG. 1 is a schematic side view of a machine in accordance with the present invention;

FIG. 2 is a schematic plan view of part of a line comprising the machine of FIG. 1;

FIG. 3 is a plan view of an area of the machine of FIG. 1;

FIG. 4 is an enlarged cross section of an area of FIG. 3;

FIG. 5 is a schematic side view of a machine for producing a component of the machine of FIG. 1;

FIG. 6 is a front view of the machine of FIG. 5; and

FIG. 7 is a plan view of an alternative embodiment of the area of FIG. 3.

### DETAILED DESCRIPTION

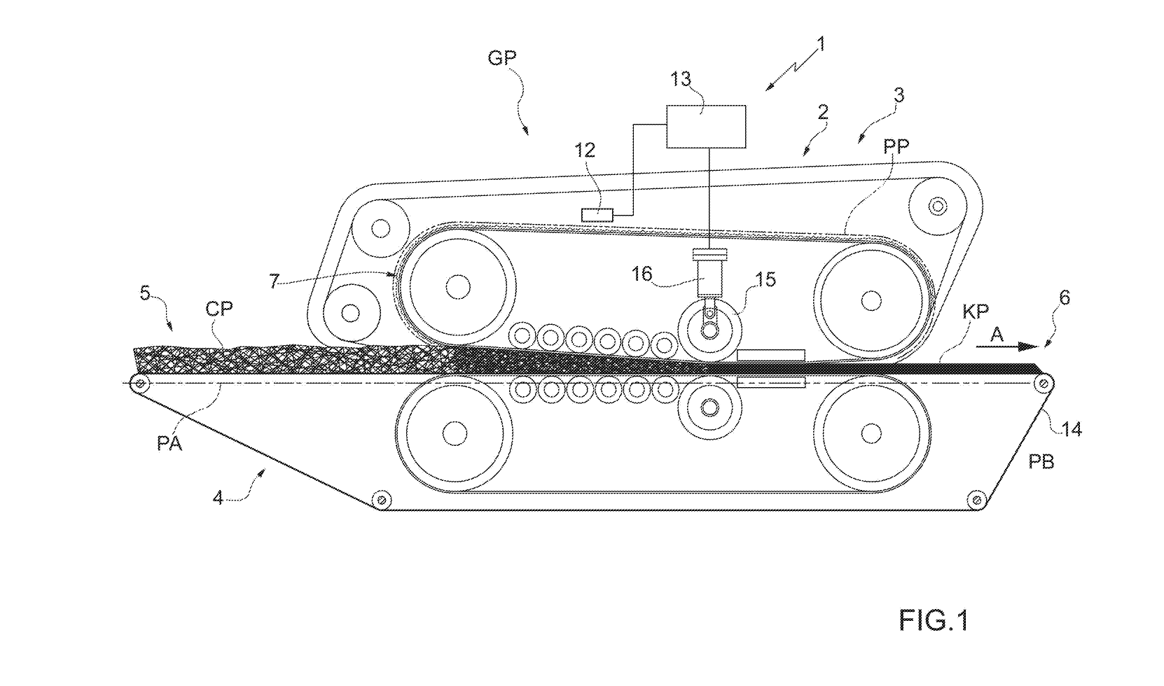

In FIG. 1, the number 1 indicates as a whole a machine for compacting powder material CP, comprising ceramic powder (in particular, the powder material CP is ceramic powder).

The machine 1 comprises a compacting device 2, which is arranged at a working station 3 and is designed to compact the powder material CP so as to obtain a layer of compacted powder material KP having a structured surface; and a conveyor assembly 4 to substantially continuously transport the ceramic powder CP along a first portion PA of a given path (from an inlet station 5) to the working station 3 (in a direction A) and the layer of compacted ceramic powder KP from the working station 3 along a second portion PB of the given path (to an outlet station 6—in the direction A).

The compacting device 2 comprises a pressure belt 7 (see, in particular, FIGS. 3 and 4), which has a structured contact surface 8 designed to come into contact with the powder material CP to obtain the structured surface of the layer of compacted powder material KP.

According to some non-limiting embodiments, the contact surface 8 (and/or the structured surface of the layer of compacted powder material KP) has differences in ridge-valley heights of up to 3 mm, more precisely up to 1 mm.

In particular, the contact surface 8 (and/or the structured surface of the layer of compacted powder material KP) has differences in ridge-valley heights of at least 0.1 mm (more precisely, of at least 0.5 mm).

More precisely, the valleys and the ridges of the contact surface 8 are designed to reproduce the aesthetic effect of natural materials such as wood and/or stone.

In particular, the pressure belt 7 is closed (in particular, in a loop).

According to some non-limiting embodiments, the pressure belt has a (continuous) base layer 9. In some cases (not necessarily), the base layer 9 comprises (more precisely is made of) metal and/or a composite material, which in turn comprises fibreglass, carbon and/or Kevlar. In particular, the base layer 9 comprises (more precisely is made of) (stainless) steel.

According to some non-limiting embodiments, the contact surface 8 is a surface of the base layer 9. More precisely, the base layer 9 has a plurality of valleys and ridges (for example, obtained by electroerosion, laser and/or grinding) which define the three-dimensional relief geometry of the contact surface 8.

Advantageously but not necessarily, an identification code 11 is obtained by etching the base layer 9. For example, the identification code 11 is obtained by electroerosion, laser and/or milling on the base layer 9.

According to some non-limiting embodiments, the pressure belt has a contact layer 10, having said structured contact surface 8. Typically, but not necessarily, the contact layer 8 is directly in contact with the base layer 9 (and is connected thereto).

In particular, the contact layer 10 comprises (consists of) one or more polymers, more in particular one or more acrylic and/or epoxy polymers.

Moreover, the pressure belt 7 has an identification code 11, which is designed to identify (in a substantially unequivocal way) the same pressure belt 7.

According to some non-limiting embodiments, the identification code 11 is any code (on any medium) suitable to perform its function. For example, the identification code 11 can be a printed code (such as a bar code and/or a QR code) or an electronic code stored on an electronic medium (e.g., a transponder). Advantageously but not necessarily, if the identification code 11 is a printed code it is made of the same material as the contact layer.

The machine 1 further comprises a detector 12 to detect the identification code 11, and a control unit 13, which is connected to the detector 12 and is designed to determine, as a function of what is detected by the detector 12, a use parameter of the pressure belt 7. The use parameter is chosen in the group consisting of: how much the pressure belt 7 is (was) used, how many times the pressure belt is (was) fitted into and/or removed from the machine 1, how long the pressure belt 7 remains (remained) removed from machine 1 (and a combination thereof).

According to some non-limiting embodiments, the use parameter is chosen in the group consisting of: how much the pressure belt 7 is (was) used, how many times the pressure belt is (was) fitted into and/or removed from the machine 1 (and a combination thereof). In some specific non-limiting cases, the use parameter is how much the pressure belt 7 is (was) used, in particular the length of the layer of compacted powder material KP produced using the pressure belt 7.

According to alternative non-limiting embodiments, the control unit 13 is designed to estimate how much the pressure belt 7 was used as a function of a length chosen from the group consisting of: the length of the layer of compacted powder material KP transported by the conveyor assembly 4 (from the time that the presence of the pressure belt 7 was detected by the detector 12 by detecting the identification code 11), the length covered by the pressure belt 7 (from the time that the presence of the pressure belt 7 was detected by the detector 12 by detecting the identification code 11) and a combination (and/or derivation) thereof.

In particular, the pressure belt 7 extends along a closed path PP (in a loop).

Advantageously but not necessarily, the detector 12 is arranged in a given position GP in the area of the closed path PP; the control unit 13 is designed to estimate how much the pressure belt 7 is (was) used as a function of the number of times the detector 12 detects (detected) the passage of the identification code 11 in the given position GP.

Alternatively or additionally, the control unit 13 is designed to estimate how much the pressure belt 7 is (was) used as a function of the length of the layer of compacted powder material KP transported by the conveyor assembly 4 from the time that the presence of the pressure belt 7 is detected by the detector 12 by detecting the code.

Alternatively or additionally, the control unit 13 is designed to estimate how much the pressure belt 7 is (was) used as a function of the length covered by the pressure belt 7.

Advantageously but not necessarily, the control unit 13 is designed to indicate when the use of the pressure belt 7 must be interrupted (e.g., as it is estimated that the contact surface 8 is worn beyond a given limit) as a function of the use parameter.

In particular, the control unit 13 is designed to indicate when the use of the pressure belt 7 must be interrupted when a reduction of the contact layer 10 of at least 300 μm is estimated. Alternatively or additionally, the control unit 13 is designed to indicate when the use of the pressure belt 7 must be interrupted when a reduction of the contact layer 10 of at least 30% (in particular, of at least 50%) is estimated.

According to some non-limiting embodiments, in use, when it is decided to interrupt the use of the pressure belt 7 (e.g. because the contact surface 8 is worn or damaged or, in any case, because the three-dimensional relief geometry of the structured contact surface 8 is to be changed) it is possible to recycle the pressure belt 7 by removing the contact layer present and producing a new contact layer 10 (with the structured contact surface 8 having a different relief geometry). In these cases, it is also necessary to affix a new identification code 11.

An example of how the contact layer 10 can be removed is described in the patent application by the same applicant with the publication number WO2015114433A1.

Advantageously but not necessarily, the control unit 13 is designed to change at least one operating parameter of the conveyor assembly 4 and/or of the compacting device 2 as a function of the aforesaid use parameter.

According to some non-limiting embodiments, the conveyor assembly 4 comprises a conveyor belt 14 which has a portion facing the pressure belt 7. In use, the powder material CP passes between the pressure belt 7 and the conveyor belt 14 so that the layer of compacted powder material KP is obtained.

In some cases, the control unit 13 is designed to adjust the distance between the pressure belt 7 and the conveyor assembly 4 at the working station 3 as a function of the use parameter. More precisely, the control unit 13 is designed to decrease the distance between the pressure belt 7 and the conveyor belt (e.g. by moving a pressure roller 15 downwards by means of a fluid dynamic actuator 16) proportionally to how much the pressure belt 7 was used. In other words, the control unit 13 is designed to decrease the distance between the pressure belt and the conveyor assembly 4 (in particular, the conveyor belt 14) as the pressure belt 7 is used.

According to some non-limiting embodiments, the control unit is designed to adjust the speed at which the conveyor assembly 4 transports the powder material CP as a function of the use parameter. In particular, the control unit 13 is designed to decrease the speed at which the conveyor assembly 4 transports the ceramic powder CP as the pressure belt 7 is used.

According to some non-limiting embodiments, the contact layer 10 is arranged on (connected to) a surface of the base layer 9, said surface having at least one free area 17 in which there is no contact layer 8. In these cases, the identification code 11 is arranged in the free area 17. In particular, the free area 17 is arranged at one of the longitudinal edges 18 of the base layer 9.

The pressure belt 7 of the specific and non-limiting embodiment illustrated in FIG. 3, has two free areas 17, which each extend along the whole of a respective longitudinal edge 18 of the base layer 9.

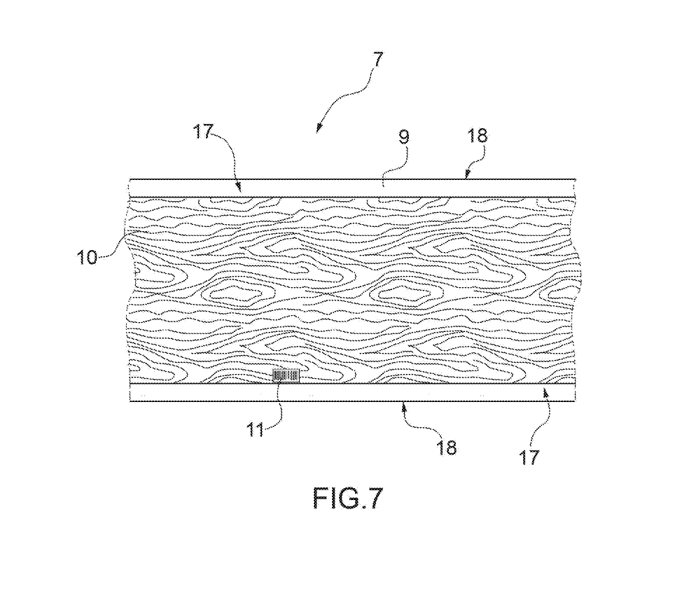

According to some non-limiting embodiments (with particular reference to FIG. 7), the detector 12 is (also) designed to detect the height of at least one part of the contact layer 10, more precisely of at least part of the identification code 11. In particular, in these cases, the control unit 13 is designed to estimate the wear of the contact surface 8 as a function of the height detected by the detector 12.

Advantageously but not necessarily (in these cases), the identification code 11 is arranged at the contact layer 10 (more precisely, is produced on the contact layer 10). In this way, the identification code 11 is substantially subjected to the same type of wear as the layer of contact 10 (and therefore as the contact surface 8).

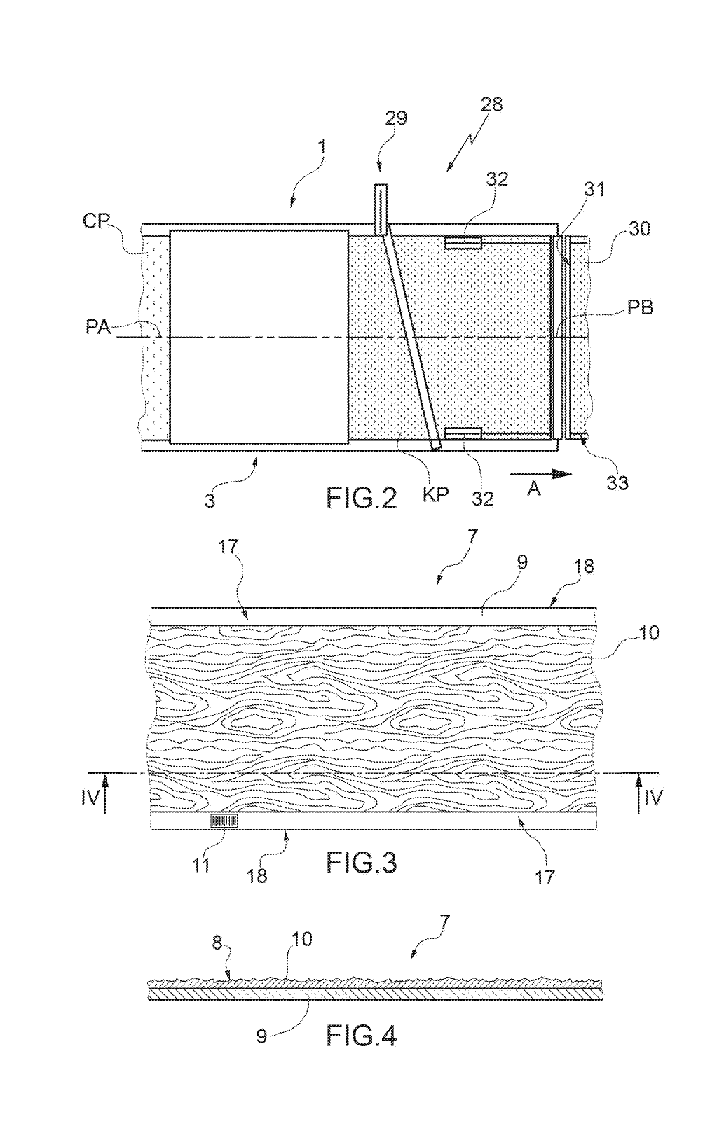

According to some non-limiting embodiments, the identification code 11 is arranged at a lateral edge of the contact layer 10 (close to the free area 17 or, where the free area 17 is not provided, to the edge 18). In this way, the part of the compacted powder material KP that comes into contact with the identification code can be removed by a blade 32 (illustrated schematically in FIG. 2 and which is described in more detail below), which is arranged on one side of the portion PB and is designed to cut the layer of compacted ceramic powder KP longitudinally (in the direction A).

Further details of the machine 1 can be obtained from the patent EP1674227B1 by the same applicant.

It is noted that the machine 1 according to the present invention offers various advantages with respect to the state of the art. Among these we mention the possibility of obtaining ceramic articles of homogenous quality, the increase in production efficiency and the reduction in rejects and production costs.

According to some non-limiting embodiments, the contact layer 10 is obtained using additive synthesis methods, in particular using the ink-jet printing method with, for example, photo-hardening plastic materials, and/or plastic materials comprising a heat-hardening fraction.

Advantageously but not necessarily, the identification code 11 is also obtained in the same way as the contact layer 10. In particular, the identification code 11 and the contact layer 10 are obtained simultaneously.

In the case in which the ink to be sprayed is 100% of the photo-hardening type, i.e., made of acrylate or epoxy monomers and oligomers, with the addition of photo-initiator substances, cross-linking only takes place due to the UV radiation coming from a suitable lamp. Alternatively, to give the layer deposited on the belt special characteristics of resistance, the aforesaid ink can be of the two-stage type, with mixed UV and heat crosslinking.

Inks of this type contain a fraction, variable from 10% to 90%, of monomers and/or oligomers chosen from the following families: pure acrylics, polyester acrylates, polyurethane acrylates, epoxy acrylates, vinyls, epoxies.

Said monomers and/or oligomers are not crosslinked by UV radiation, but for their radical polymerisation require a heat treatment at a temperature ranging between 150° C. and 200° C. for a time of at least 15 minutes.

Therefore, the UV light acts as a “temporary block” that, by acting on the fraction sensitive to ultraviolet light, prevents the design from deteriorating; the final heat treatment permanently fixes the entire mass.

In general, the structure can be produced with a series of applied layers of different materials (photo-hardening and two-stage).

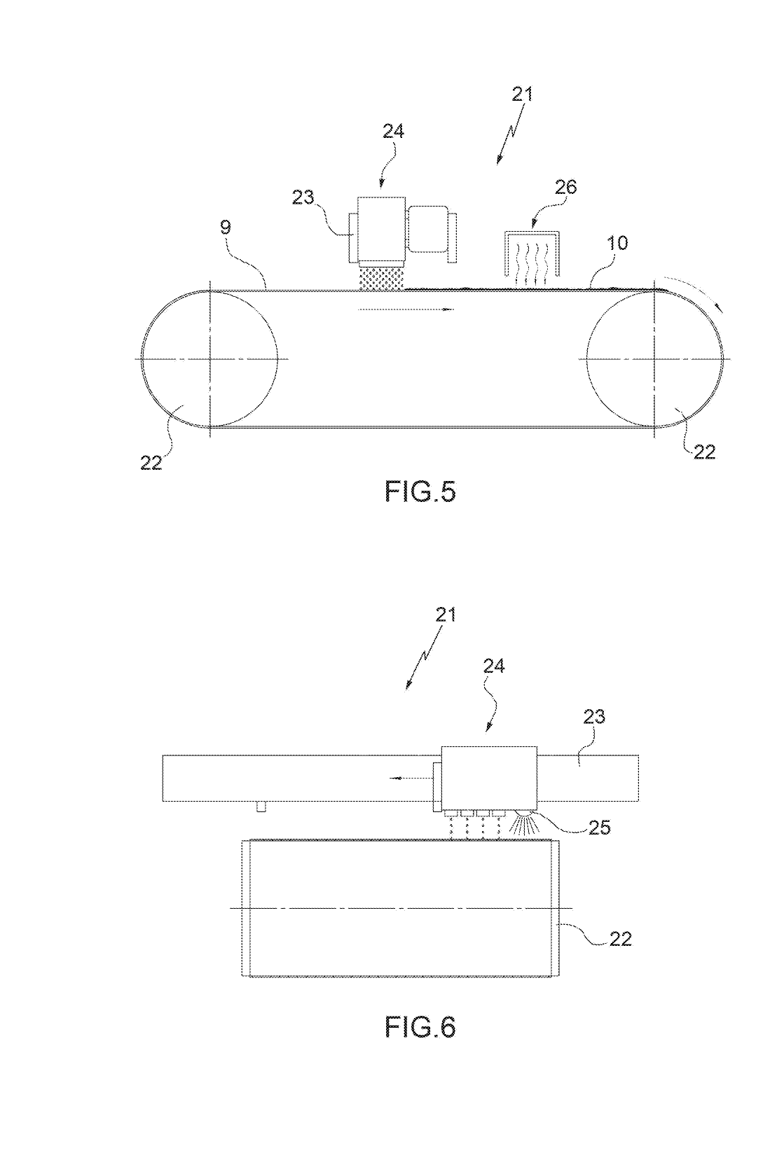

FIGS. 5 and 6 schematically illustrate a non-limiting example of a machine 21 for producing the pressure belt 7. The machine 21 comprises a pair of rollers 22, at least one of which is motorised and on which the base layer 9 is fitted (closed—in particular, in a loop).

There is also provided a beam 23, which is arranged above the rollers 22 (and the base layer 9), extends transversely to the base layer 9 and supports a printing head 24 equipped with a plurality of inkjet heads and a lamp 25 for emitting UV radiation. Actuator means (known and not illustrated) are designed to move the printing head 24 along the beam 23.

The machine 21 also comprises a heat source 26 arranged downstream of the printing head with respect to the direction of movement imparted by the rollers 22 on the base layer 9.

In use, while the base layer 9 is moved around the rollers 22, the printing head 24 is operated so as to decorate a surface of the base layer 9 with an ink as describe above. The UV radiation emitted by the lamp 25 determines a first partial hardening of the ink. This hardening is completed by the heat source 26 so as to obtain the contact layer 10 (and therefore the pressure belt 7). At this point, the pressure belt 7 obtained is removed from the machine 21 and fitted into the machine 1 where it is used until replacement with a new pressure belt.

Further characteristics and details of the machine 21 and/or of the production of the pressure belt 7 can be obtained from the patent application by the same applicant with the publication number WO2015114433A1.

In accordance with a further aspect of the present invention (see in particular FIG. 2), there is provided a line 28 for the production of ceramic articles (in particular, tiles); the line 28 comprises at least the machine 1 for compacting a powder material according to the description above and is equipped with a cutting assembly 29 to transversely cut the layer of compacted powder material KP so as to obtain slabs 30, each having a portion of the layer of compacted powder material KP.

The line 28 further comprises at least one baking oven (of a known type and not illustrated) to sinter the compacted powder material KP of the slabs 30 so as to obtain the ceramic articles.

Advantageously, the cutting assembly 29 comprises a cutting blade, which is designed to come into contact with the layer of compacted ceramic powder KP to cut it and a movement unit to move the cutting blade along a trajectory diagonal with respect to the direction A of advance of the layer of compacted powder material KP. In this way, it is possible to provide the slabs 30 with end edges 31 substantially perpendicular to the direction A while the layer of compacted ceramic powder KP advances with a continuous motion.

According to some non-limiting embodiments (such as those illustrated in FIGS. 1 and 2), the cutting assembly 14 also comprises two further blades 32, which are arranged on opposite sides of the portion PB and are designed to cut the layer of compacted ceramic powder KP and define lateral edges 33 of the slabs 30 substantially perpendicular to the edges 31 (and substantially parallel to the direction A). In some specific cases, the cutting assembly 29 is like the one described in the patent application with publication number EP1415780.

In accordance with a further aspect of the present invention, there is provided a plant for the production of ceramic articles (in particular, tiles); the plant comprises at least two machines 1 for compacting a powder material CP as described above. The plant also comprises a control assembly that comprises the control unit 13 of the machines 1 and is designed to estimate the use parameter as a function of what is detected by the detectors 12 of the machines 1. In particular, the control assembly is designed to add up the use parameters determined by the control units of the machines 1.

Unless expressly indicated to the contrary, the content of the references (articles, books, patent applications, etc.) cited in this text is a considered an integral part, in its entirety. In particular, the aforesaid references are incorporated herein for reference.

1. A machine for compacting a powder material comprising ceramic powder; the machine (1) comprising:
a compacting device, which is arranged at a working station and is configured to compact the powder material so as to obtain a layer of compacted powder material having a structured surface; and
a conveyor assembly configured to substantially continuously transport the ceramic powder along a first portion of a given path to the working station and the layer of compacted powder material from the working station along a second portion of the given path;
the compacting device comprising a pressure belt, which has a structured contact surface, which is configured to come into contact with the powder material so as to obtain the structured surface of the layer of compacted powder material;
the pressure belt having an identification code, which is configured to identify the pressure belt (7);
the machine further comprising a detector to detect the identification code and a control unit, which is connected to the detector and is configured to determine, as a function of what is detected by the detector, a use parameter chosen in the group consisting of: how much the pressure belt was used, how many times the pressure belt was fitted into and/or removed from the machine, how long the pressure belt remained removed from the machine, and a combination thereof.

2. The machine according to claim 1, wherein when the use parameter is how much the pressure belt was used, how much the pressure belt was used is the length of the layer of compacted powder material produced using the pressure belt.

3. The machine according to claim 1, wherein the pressure belt extends along a closed path and the detector is arranged in a given position at the closed path; the control unit is configured to estimate how much the pressure belt is used as a function of the number of times the detector detects the passage of the identification code in the given position.

4. The machine according to claim 1, wherein the control unit is configured to estimate how much the pressure belt was used as a function of a length chosen in the group consisting of: the length of the layer of compacted powder material transported by the conveyor assembly, the length covered by the pressure belt, and a combination and/or derivation thereof.

5. The machine according to claim 1, wherein the pressure belt has a base layer and a contact layer, having said structured contact surface; the contact layer comprises one or more polymers including one or more acrylic and/or epoxy polymers.

6. The machine according to claim 1, wherein the control unit is configured to indicate when the use of the pressure belt should be interrupted as a function of the use parameter.

7. The machine according to claim 1, wherein the control unit is configured to change at least one operating parameter of the conveyor assembly and/or of the compacting device as a function of the use parameter.

8. The machine according to claim 7, wherein the control unit is configured to adjust the distance between the pressure belt and the conveyor assembly at the working station as a function of the use parameter; wherein, the control unit is configured to decrease the distance between the pressure belt and the conveyor assembly proportionally to how much the pressure belt was used.

9. The machine according to claim 7, wherein the control unit is configured to adjust the speed at which the conveyor assembly transports the powder material as a function of the use parameter; wherein, the control unit is configured to decrease the speed at which the conveyor assembly transports the ceramic powder in case of an increase in how much the pressure belt was used.

10. The machine according to claim 1, wherein the pressure belt has a base layer and a contact layer, having said structured contact surface; the contact surface is connected to a surface of the base layer, said surface having at least one free area where there is no contact layer; the identification code being arranged in the free area; the free area (17) being arranged at an edge of the base layer.

11. The machine according to claim 1, wherein the detector is designed to detect the height of at least part of the identification code; wherein, the control unit (13) is configured to estimate the wear of the contact surface as a function of the height detected by the detector.

12. A line for the production of ceramic articles; the line comprising at least one machine for compacting a powder material (CP) according to claim 1, which is provided with a cutting assembly to transversely cut the layer of compacted powder material so as to obtain slabs, each having a portion of the layer of compacted powder material; and at least one baking oven to sinter the compacted powder material of the slabs so as to obtain the ceramic articles.

13. A plant for the production of ceramic articles; the plant comprising a first machine for compacting a powder material according to claim 1 and at least a second machine for compacting a powder material according to claim 1; the plant also comprising a control assembly, which comprises the control units of the first and the second machine and is configured to estimate the use parameter as a function of what is detected by the detectors of the first and the second machine; wherein, the control assembly is configured to add up the use parameters determined by the control units of the first and the second machine.

14. A method for compacting a powder material comprising ceramic powder; the method being performed by a machine for compacting powder material, the method comprising:
a detection step, during which a detector of the machine detects an identification code; and
a control step, during which a control unit of the machine determines, as a function of what is detected by the detector, a use parameter chosen in the group consisting of: how much a pressure belt of the machine was used, how many times the pressure belt was fitted into and/or removed from the machine, how long the pressure belt remained removed from the machine and a combination thereof.

15. The method according to claim 14, wherein the pressure belt extends along a closed path and the detector is arranged in a given position at the closed path; during the control step, the control unit estimates how much the pressure belt is used as a function of the number of times the detector detects the passage of the identification code in the given position.

16. The method according to claim 14, wherein the control unit changes at least one operating parameter of the conveyor assembly and/or of the compacting device as a function of the use parameter.

17. The method according to claim 16, wherein the control unit adjusts the distance between the pressure belt and the conveyor assembly at the working station as a function of the use parameter; wherein, the control unit decreases the distance between the pressure belt and the conveyor assembly proportionally to how much the pressure belt was used.

18. The method according to claim 16, wherein the control unit adjusts the speed at which the conveyor assembly transports the powder material as a function of the use parameter; wherein, the control unit decreases the speed at which the conveyor assembly transports the ceramic powder in the case of an increase in how much the pressure belt was used.

19. The method according to claim 14, wherein when the use parameter is how much the pressure belt (7) was used, how much the pressure belt was used is the length of the layer of compacted powder material produced using the pressure belt.
